(19) United States
(12) Patent Application Publication
(10) Pub. No.: US 2015/0258764 A1
(43) Pub. Date: Sep. 17, 2015

(54) RAISED SEAM

(71) Applicant: FORD GLOBAL TECHNOLOGIES, LLC, Dearborn, MI (US)

(72) Inventors: JÖrg Saßmannshausen, Leverkusen (DE); Joerg Frietsch, Hennef (DE); Ernst Stefan Dittus, Weisbaum (DE); Heinz Dittrich, Orlenbach (DE)

(21) Appl. No.: 14/425,993

(22) PCT Filed: Sep. 4, 2013
(86) PCT No.: PCT/EP2013/068273

§ 371 Date: Mar. 4, 2015

(30) Foreign Application Priority Data
Sep. 5, 2012 (DE) 10 2012 215 715.8
Oct. 1, 2012 (DE) 10 2012 217 960.7

(51) Int. Cl. B32B 38/00; F16B 11/00; B32B 37/00; B32B 37/18; B32B 37/12

(52) U.S. Cl. CPC B32B 38/0012; B32B 37/18; B32B 37/1292; B32B 37/0076; B32B 38/0036; F16B 11/00; B32B 2037/1253; B32B 2305/02; B32B 2605/00

(57) ABSTRACT

The invention relates to a method for producing a double-flanged seam (1) between an inner component (2) having a free edge section (4) and an outer component (3) having a fold edge (7) arranged on an edge section (6), comprising at least the following steps:
producing an adhesive structural element (8) with an extension adjusted to a fold gap (11) to be added later on, the extension being shorter than the extension of the fold gap (11), wherein the adhesive structural element (8) has an expandable structural adhesive,
applying the adhesive structural element (8) in the cold condition onto one of the components (2, 3) on its side facing the other component (2, 3),
crimping over the fold edge (7) toward the inner component (2), wherein
the adhesive structural element (8) is bent over with an excess length (13) around the free edge (4) of the inner component (2) at the latest when crimping over the fold edge (7), and
heating up at least the area of the double-flanged seam, thus melting the structural adhesive causing it also to leak from the fold gap (11) in a manner expanding in all directions and forming a sealing bead (26, 27).

The present invention relates to a method for producing a double-flanged seam between an inner component having a free edge section and an outer component having a fold edge arranged on an edge section.

DE 10 2008 060 930 A1 is concerned with a combined folded and adhesive joint on a body part of a motor vehicle, wherein an outer part of the body part is folded in a peripheral region about a peripheral region of an inner part of the body part, wherein an adhesive surrounds the peripheral region of the inner part on both sides. The production of the folded and adhesive joint is intended to be simplified if the adhesive is formed by a strip adhesive which can be shaped at least during the production of the folded and adhesive joint.

Double-flanged seams, which can also be referred to as folded seams, are used for connecting an inner panel to an outer panel. The two components here are designed to be connected to each other by bending the fold edge on the outer panel around the free edge section of the inner component. However, it is difficult to protect the double-flanged seam from corrosive action since moisture can accumulate in the folded seam, i.e. moisture permanently remaining in the folded seam, the moisture having an accelerating effect on the corrosive process. Also, it is known that, in the event of a merely frictional metal on metal contact, the double-flanged seam does not have the required strength properties, required, for example, in vehicle manufacturing. Double-flanged seams are used, for example, on hoods, doors or the like. It is known therefore to provide the fold gap with suitable means in order to avoid the formation of corrosion and in order to be able to make the joint more resistant as a whole.

For this purpose, use is made, for example, of adhesives, as disclosed, for example, in WO 94/21740. WO 94/21740 is based on a method for achieving an adhesive joint in a folded seam between an inner part and an outer part using a cold epoxy adhesive applied to the surface of the edge region of the outer part, which surface is in contact with the edge region of the inner part. The two parts are brought one onto the other, with the fold edge being bent over. After the folded seam is completed, the adhesive strip is applied and pressed around the joint, but the adhesive does not cover the entire double-flanged seam. Therefore, an air bubble may be trapped in the double-flanged seam, this being intended to be prevented by the teaching of WO 94/21740 by an adhesive strip being applied in a hot phase before the two components are brought together and also before the folding. Air bubbles can therefore probably be avoided. However, the hot and liquid adhesive is pressed out of the folded seam during the folding-over operation, and therefore the adhesive can form drops which, when they drip off, may result in soiling of the assembly line and of tools in the following assembly stations.

In order to avoid such soiling, provision is intended to be made for the adhesive to cure before further processing of the component. However, this has a disadvantageous effect on the production cycle and is also complicated and unprofitable from an industrial management aspect.

EP 0 892 180 A1 proposes surrounding the inner component, around the free edge section thereof, with a preshaped adhesive body. The adhesive body is of U-shaped design in such a manner that it is kept attached to the free edge section by clamping force. A double-sided adhesive strip can optionally also be applied to the longer of the two U limbs such that an adhesive force can act in addition to the clamping force. If the adhesive body is fitted, the components are brought together, with the double-flanged seam being completed by bending over the fold edge. The adhesive body is then softened such that the components are wetted at the point of adhesion. The point of adhesion is then cured.

DE 36 21 758 discloses a method for sealing a folded joint by means of a double-flanged seam adhesive, which can be cured by a supply of heat, in the fold gap and by means of a sealing layer which is connected upstream of said fold gap, consists of a material which can be cured by a supply of heat, and is applied to the cut edge of the folded joint, wherein the folded joint is subjected to at least one heat treatment. At least the double-flanged seam is heated to the curing temperature, with the sealing layer being applied to the heated cut edge.

Accordingly, the production of a double-flanged seam with a pasty adhesive is a critical process in respect of corrosion protection, but also in respect of a filling, as intended, of the double-flanged seam by means of the adhesive. In addition, provision is made for the adhesive to be subjected to preliminary curing, with individual weld points also being provided in order to prevent a relative movement of the two components to be connected. Up until now, a filling rate of 100/100/>0 can be achieved only by squeezing the adhesive out of the double-flanged seam, and this involves a considerable outlay on cleaning, as already indicated above with regard to WO 94/21740. The joint can be inspected by an inspection similar to a statistical process control (SPC), but non-destructive inspection methods for verifying whether the double-flanged seam is correctly filled are still not adequately used.

DE 195 04 482 A2 discloses a method and a device for adhesive connection using non-compressible particles which are mixed with an adhesive. The adhesive mixture is applied to one of the parts, wherein the one part is folded over the other in an overlapping position.

EP 0 030 918 A1 is concerned with a method and an apparatus for the application of an adhesive strip onto the edge of a shaped panel part. An adhesive film strip matched to the shape of the edge of a shaped panel part is placed here over a correspondingly shaped and formed slot, wherein the panel is introduced by the edge thereof to be enclosed with the strip into the slot, and then jaws are pressed together until the foil strip adheres to the panel.

DE 693 23 181 T2 is predominantly concerned with an induction heating coil which is intended to heat a heat-curable, adhering connection material, wherein a folded joint is also discussed. The connecting material is squeezed during the bending-over operation.

DE 21 62 361 discloses a method and means for sealing joints and connections of all types of profile, using a plastic adhesive. The sealing means is applied in a pasty state to a flat carrier in the shape of a band, is inserted into the joint and cures.

DE 101 16 719 A1 proposes the use of a post-crosslinking hot-melt adhesive, wherein the post-crosslinking hot-melt adhesive is provided as a sealing layer after the flanging operation. DE 32 38 651 A1 also discloses that a sealing bead is intended to be applied to the free cut edge of a folded joint. The sealing bead is heat-treated in two stages. By contrast, DE 35 40 520 A1 teaches that the heat treatment of the material covering the free cut edge of the folded joint could be dispensed with by using a material having thermoplastic properties.

Against this background, the present invention has been set the object of indicating a method for producing a double-flanged seam, with which it can be ensured that the double-flanged seam is protected against corrosion, wherein inadvertent trapping of air can be eliminated and wherein the use of an additional edge sealing can be dispensed with.

This object is achieved by a method with the features of claim 1. The dependent claims disclose further, particularly advantageous refinements of the invention.

It should be emphasized that the features cited individually in the description below can be combined with one another in any technically expedient manner and indicate further refinements of the invention. The description characterizes and specifies the invention, in particular, additionally in conjunction with the figures.

According to the invention, a method for producing a double-flanged seam between an inner component having a free edge section and an outer component having a fold edge arranged on an edge section comprises at least the following steps:

producing an adhesive structural element with an extension adjusted to a fold gap to be added later on, the extension being shorter than the extension of the fold gap, wherein the adhesive structural element has an expandable structural adhesive,
applying the adhesive structural element in the cold condition onto one of the components on its side facing the other component,
crimping over the fold edge toward the inner component, wherein
the adhesive structural element is bent over with an excess length around the free edge of the inner component at the latest when crimping over the fold edge, and
heating up at least the area of the double-flanged seam, thus melting the structural adhesive causing it also to leak from the fold gap in a manner expanding in all directions and in each case forming a sealing bead.

The invention results in a double-flanged seam which is protected against corrosion and is furthermore sealed at the relevant points thereof without the additional use of a special sealing material by the sealing bead being formed.

In an advantageous embodiment, the adhesive structural element is applied to one of the components, with a fastening portion and the excess length being formed. In a preferred refinement, the excess length is dimensioned in such a manner that said excess length, after bending around the free edge of the inner component, is shorter than the fold edge in the bent-over state. In this respect, the adhesive structural element has an extension, i.e. a width, which is shorter than the extension of the fold gap.

In a preferred refinement, the adhesive structural element is applied to the inner component in such a manner that the fastening portion adheres to the inner component. The excess length protrudes over the free edge of the inner component. It is possible for the adhesive structural element to have an adhesive side which has a protective element which can be peeled off. In a preferred embodiment, the adhesive side of the excess length is freed from the protective element. The adhesive side here may contain an adhesive. However, it is preferred to apply the adhesive structural element to the inner component when the adhesive structural element is in the cold condition in which said adhesive structural element has little stickiness, i.e. a low tack. The adhesive structural element is heated up, thus increasing the stickiness. The fastening portion can thus be stuck to the inner component. The excess length will likewise increase the stickiness thereof, i.e. the tack thereof, upon being heated.

If the adhesive structural element is applied to the inner component, i.e. is stuck by the fastening portion thereof to the inner component, the inner component and the outer component are joined or joined together. In this joining process, the excess length is already correspondingly moved along or deformed such that the excess length is arranged, for example, parallel to the profile of the fold edge. Since the adhesive side does not have any contact with the fold edge, the adhesive structural element correspondingly slides along the fold edge and is moved along without adhering. In this state, the adhesive structural element bears with its structural side opposite the adhesive side against the outer component, i.e. against the fold edge. The fold edge is subsequently crimped over toward the inner component such that the double-flanged seam, i.e. the folded seam, is formed. During the folding of the fold edge, the excess length of the adhesive structural element is correspondingly, i.e. forcibly, moved along, with the adhesive side bearing against the free edge, but also against the inner component. The inner component is enclosed at the free edge section thereof in regions, i.e. virtually, by the adhesive structural element.

The double-flanged seam is produced in the cold condition, wherein the adhesive structural element in the cold condition is shorter than the fold gap. The adhesive structural element is arranged here with the inner, free edge thereof within the fold gap and is spaced apart from a transition of the free edge section from the inner component. The outer free edge of the adhesive structural element, which edge is opposite the inner free edge, is likewise spaced apart within the fold gap, but from the free edge of the fold edge. An expansion space is thus provided in each case for the adhesive structural element when the latter is heated in the area of the double-flanged seam on account of the action of heat. It is advantageous here for the structural adhesive to form the sealing bead on emerging from the fold gap and therefore dripping of liquid or pasty adhesive is avoided. The sealing bead here settles firstly around the free edge of the fold edge and secondly in the intermediate space between the outer component and the inner component, bridging the transition of the free edge section of the inner component. It is advantageous that the adhesive structural element here has multiple functions. First of all, a connection is provided between the inner component and the outer component, said connection withstanding the corresponding requirements in respect of corrosion protection and strength and similar mechanical requirements, wherein, secondly, it is possible to dispense with a particular and additional encasing or sealing material, since the sealing bead is formed. Upon heating, the adhesive structural element expands, but the structural adhesive not only emerging from the fold gap, but also in such a manner that the entire fold gap is filled avoiding trapping of a medium, wherein the two components are connected to each other by the adhesion of the adhesive structural element.

In a further advantageous refinement of the method, provision can be made, in a first intermediate step before the two components are joined together, to form the excess length of the structural adhesive element just in the direction of the free edge of the free edge section of the inner component such that the adhesive side adheres to the free edge. The two components can subsequently be drawn together, and the previously described steps are carried out.

However, it is also possible, in a second intermediate step, to mold the excess length completely around the free edge before the two components are joined together, and therefore the structural adhesive element encloses the free edge section in some regions and adheres thereto. The two components can subsequently be joined together, wherein the fold edge is folded in the direction of the inner component. The heating follows.

In a preferred refinement, the adhesive structural element can be applied by means of a preferably stationary application head to the component to be adhesively bonded. The adhesive structural element is then placed around the component edge by means of hot air nozzles, foam rollers or brushes, to mention just a few possible examples. The hot air causes softening and sufficient adhesion of the adhesive structural element to the metal surface even if the latter is greasy, oily or covered in some other way. In other words, the adhesive structural element is slightly heated and pressed onto the inner component. However, it is also conceivable for the adhesive structural element to be pressed on with mechanical means and without previous heating, wherein the adhesive structural element adheres to the inner component.

The preferably stationary application head for the adhesive structural element permits the application of materials with a variable width and thickness. The application head can also have a cutting device for exact cutting of the adhesive structural element to be used to size.

The method according to the invention can be used for any form of bent-over flange joints and can be used for galvanized steel, non-galvanized steel, aluminum and also magnesium components without being restricted to the materials mentioned.

The complete curing of the adhesive structural element can take place, for example, in an electric coating furnace, but curing can also take place by means of any heating-up method.

In a preferred embodiment, the adhesive structural element can be fastened by the fastening section thereof to that side of the free edge section of the inner component facing the outer component, wherein the excess length is then deformed, i.e. is bent around the free edge, this being carried out at the latest together with the folding of the fold edge after the two components have been joined together. However, it is also possible first of all to fasten the excess length to the free edge section of the inner component on the side opposite the outer component and then to implement the bending operation around the free edge.

However, it is also conceivable for the adhesive structural element to be placed by the adhesive side thereof onto the free edge of the free edge section of the inner component, wherein the adhesive structural element is deformed by the protruding limbs thereof, i.e. by the excess length thereof and by the fastening section, toward the free edge section such that a structural element surrounding the free edge section in some regions likewise adheres to the free edge section.

In a further possible embodiment, provision can be made for the adhesive structural element to be placed on that side of the outer component which faces the inner component, wherein the fold edge is partially covered by the excess length. The two components can be joined, folded and the double-flanged seam produced with subsequent heating.

As already mentioned, the adhesive structural element can have just one adhesive side which is provided, for example, with the protective element which is removed prior to application. In a preferred refinement, the protective element is designed as a protective film, that is to say as a peelable film, which can easily be peeled off from the adhesive side. It is particularly advantageous if the adhesive structural element is designed as a hot-melt sealing tape which expands after heating and, filling the fold gap in all directions, thus has the required property. It is also possible for the adhesive structural element to be designed as a hot-melt sealing tape which is adhesive on one side.

The adhesive structural element can be applied to the respective component piece by piece, i.e. in sections, or as a strip of respectively adaptable length, which means that the respective piece of adhesive structural element also only covers part of the circumference of the component concerned, with the entire circumference being able to be covered by arranging a plurality of individual structural adhesive pieces or strips next to one another. In this respect, the adhesive structural element can be produced as roll stock, wherein the appropriate length required in each case can be severed, which, of course, can take place in an automated manner. In a further possible refinement, it is possible to produce an adhesive structural element which is adapted to the circumference of the components and can be applied in one piece to the component concerned. In this respect, the adhesive structural element can be produced in the form of piece goods matched to the component concerned. The adhesive structural element can have a thickness of 0.3 to 1 mm, but this, of course, is not intended to be limiting. The aim, however, in each case is for the width of the adhesive structural element preferably to be dimensioned in such a manner that the fold gap is not completely filled in the cold state.

In a further advantageous refinement, provision can be made for the adhesive element to be placed in the cold condition onto the free edge, i.e. onto an end edge of the inner component, thus forming the excess length and the fastening portion which both protrude over the end edge, for example as previously described.

The adhesive structural element, which can also be referred to as an adhesive strip, is heated and glued to one side or to both sides of the inner component. The inner component is placed onto the outer component, wherein the fold edge, which can also be referred to as fold flange, is crimped over toward the inner component. Subsequently, at least the area of the double-flanged seam is heated in order to cure the adhesive strip.

In the case of double-flanged seams of the type in question, adhesive is required on both sides of the free edge section of the inner component, wherein the free edge section can also be referred to as the wing flange. For this purpose, the adhesive structural element is applied to the end edge of the wing flange, wherein the adhesive structural element is in the cold condition, i.e. has little stickiness or low tack and is also relatively stiff. However, such an adhesive structural element cannot bend in both directions around the end edge of the wing flange. By heating following the application, the adhesive structural element becomes sticky and remains stuck to the end edge. At the same time, it becomes soft and can be glued to both sides of the wing flange.

During the heating, the adhesive structural element should be heated only to an extent such that it does not cure or starts the curing process. The heating is intended to take place only to such an extent as to make the adhesive structural element sticky and soft so that the latter can be glued to the wing flange, which generally does not have a rectilinear profile. This method enables an adhesive structural element which can be difficult to handle to be securely applied to a curved wing flange.

The adhesive structural element is advantageously placed onto the end edge from above. As a result, the adhesive structural element can buckle over downward under the effect of gravitational force on the right and left of the end edge during heating.

The adhesive structural element can be heated by any suitable heat source, for example infrared or laser light. Use is preferably made of hot air, through one or more nozzles.

The heated adhesive structural element is preferably glued by means of air jets which press the adhesive structural element on one or both sides against the wing flange. The increased stickiness or increased tack of the heated adhesive structural element means that the latter easily remains glued to the wing flange.

Particularly preferably, hot air serves for heating and gluing the adhesive structural element. The heating and gluing can therefore take place in one working step. Hot air nozzles which press the adhesive structural element against the wing flange by means of one hot air jet or a plurality of hot air jets are suitable for this purpose. The heated adhesive structural element immediately remains stuck there.

In an advantageous manner, the end edge of the wing flange is predominantly horizontal when the adhesive structural element is applied and/or glued on and/or the wing flange is predominantly vertical, as seen in the transverse direction, when the adhesive structural element is applied and/or glued on. If the adhesive structural element is placed onto the end edge from above, said adhesive structural element can already buckle downward under gravitational force in a uniform manner on the right and left of the end edge upon heating and can thus be glued uniformly to the wing flange.

As already mentioned, a fold gap is formed between the wing flange and fold flange, and the adhesive structural element has, at least in sections, an extension which is shorter at least at one end of the fold gap than the extension of the fold gap.

It is thus possible, for example, to produce a double-flanged seam for a vehicle door, wherein the outer and the inner components can therefore be door panels. Of course, the method according to the invention is not restricted to the production of double-flanged seams on vehicle doors, but rather includes all possible components which may have double-flanged seams.

The invention provides an improved method for producing a double-flanged seam, with which method preliminary curing can be avoided, and nevertheless no soiling due to dripping adhesive should be anticipated. In addition, the adhesive structural element is relatively thick with respect to adhesive tapes or with respect to the thickness of applied pasty pastes, and therefore, during the folding of the fold edge, adequate mechanical strength can already be achieved between the two components, as a result of which preliminary curing and even weld points can be dispensed with, since a relative movement between the components to be connected can be avoided by the thickness of the adhesive structural element and resulting mechanical stability. In addition, mechanical squeezing of material out of the fold gap during the folding operation is avoided. The adhesive structural element can be applied automatically, for example, with a robot (application head), wherein, of course, the bringing together of the two components, but also the folding process and subsequent heating, can be automated. For example, owing to the automatic application possibility, safe and controlled fastening of the adhesive structural element is possible, and this obviates the need for a subsequent inspection of a correct double-flanged seam, in particular under destructive conditions, since the same result corresponding to the requirements can always be achieved using verified method parameters. With the method, the use of additional sealing measures such as, for example, the application of a cosmetic sealing element or the application of water-repelling wax can be dispensed with.

Further advantageous details and effects of the invention are explained in more detail below with reference to exemplary embodiments which are illustrated in the figures, in which:

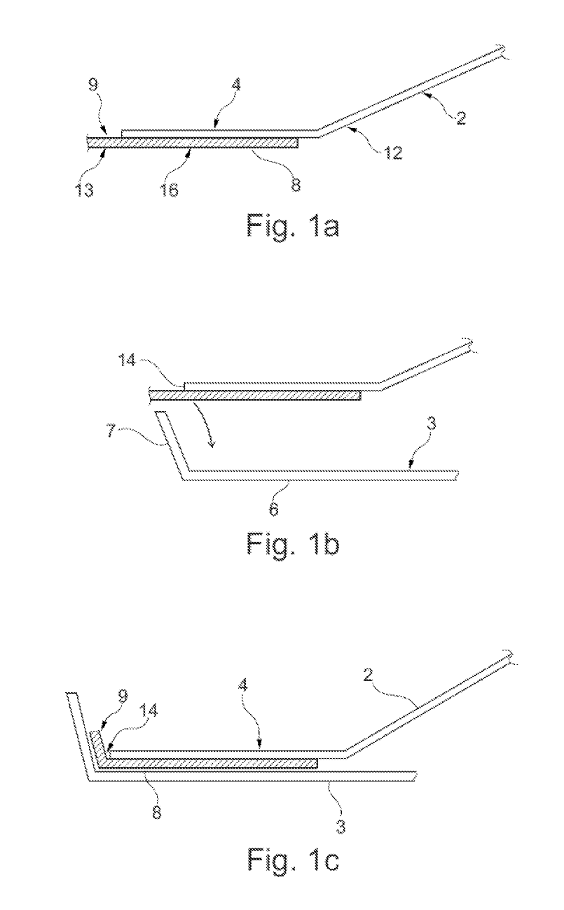

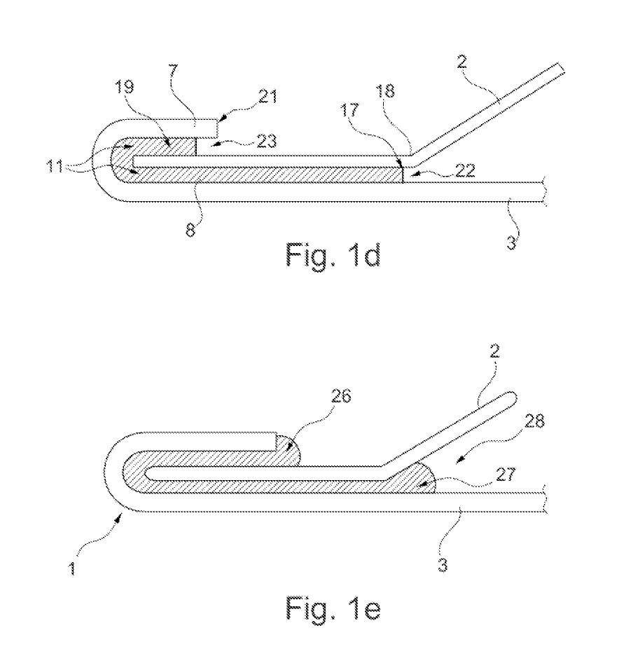

FIGS. 1a to 1e show a schematic sectional view with individual steps for producing a double-flanged seam,

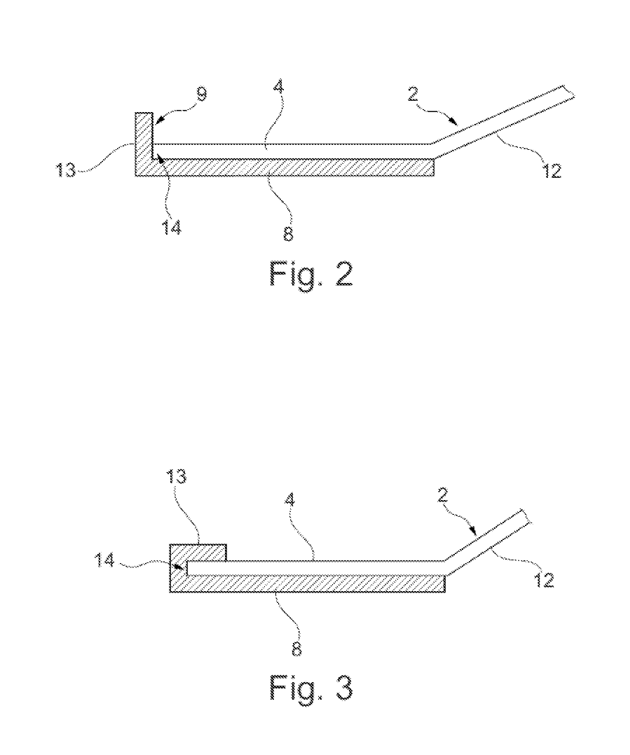

FIG. 2 shows the procedure from FIG. 1 with a first intermediate step,

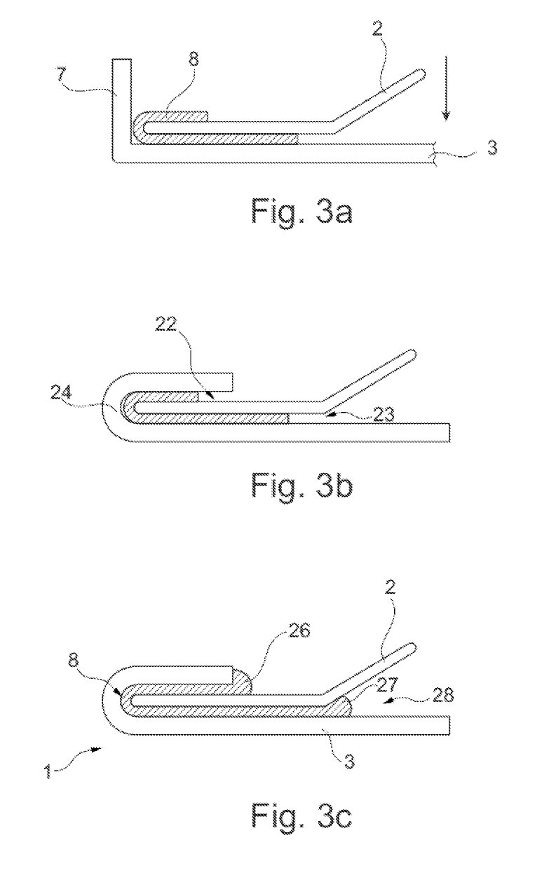

FIG. 3 shows the procedure from FIG. 1 with a second intermediate step with respect to FIG. 2,

FIGS. 3a to 3c show a schematic sectional view with individual steps for producing a double-flanged seam by the procedure according to FIG. 3,

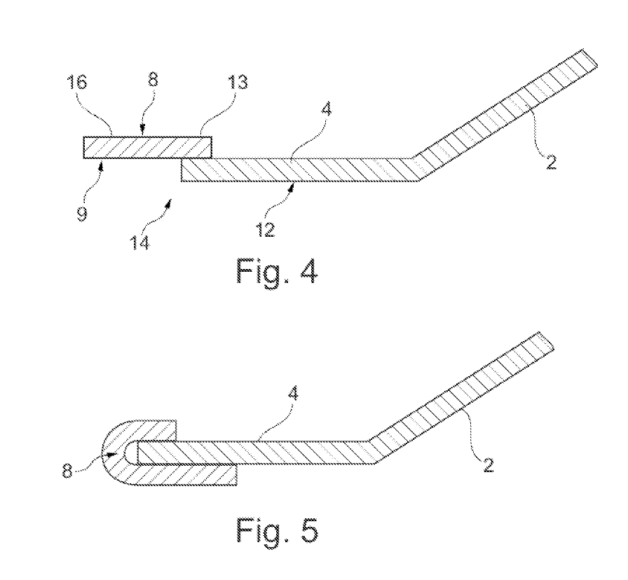

FIG. 4 shows a further embodiment for the application of the adhesive structural element,

FIG. 5 shows the adhesive structural element being guided around following the application according to FIG. 4,

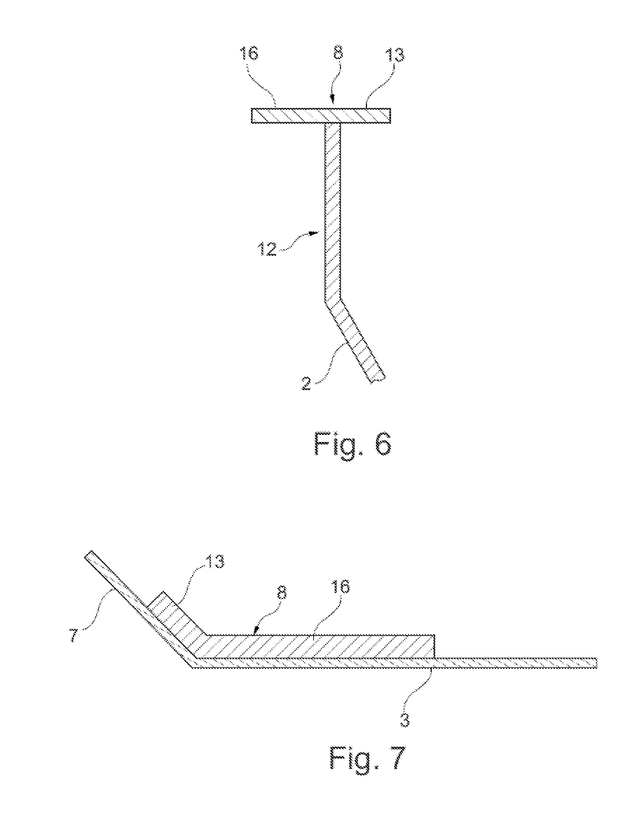

FIG. 6 shows a further embodiment for the application of the adhesive structural element,

FIG. 7 shows a further embodiment for the application of the adhesive structural element, and

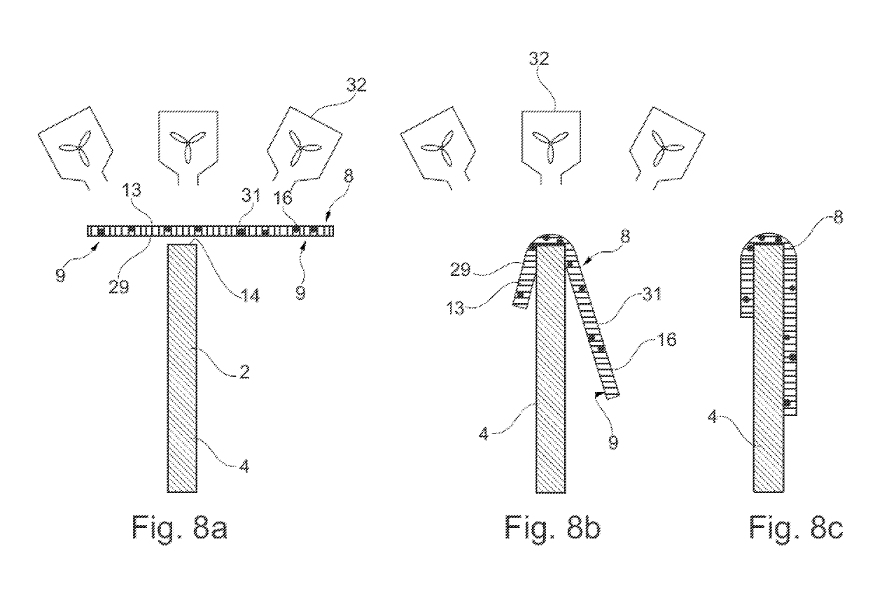

FIGS. 8a to 8c show an exemplary procedure for applying the adhesive structural element to one of the components.

The same parts are always provided with the same reference numbers in the various figures, and therefore said parts will generally also only be described once.

FIGS. 1a to 1e show a method for producing a double-flanged seam 1 between an inner component 2 and an outer component 3. The inner component 2 is, for example, an inside door panel of a motor vehicle and has a free edge section 4 which, by way of example, is arranged at an angle to the inner component 2. The outer component 3 is, for example, an outside door panel of the motor vehicle and has a fold edge 7 arranged on an edge section 6.

First of all, an adhesive structural element 8 which has an adhesive side 9 is produced. The adhesive structural element 8 is produced with such an extension that the adhesive structural element 8 is shorter than a fold gap 11 (FIG. 1d). The adhesive structural element 8 therefore has a width which is shorter, i.e. narrower, than the extension of the entire fold gap 11.

The adhesive structural element 8 can have, on the adhesive side 9 thereof, a protective element, for example in the form of a film, which has already been removed. The adhesive structural element 8 can therefore first of all be heated in order to increase the tack such that fastening is possible, since the adhesive structural element 8 is sticky. It is thus possible to refer to the adhesive side 9. If the adhesive structural element 8 is fastened, the latter will in turn cool and maintain the original low tack thereof, but nevertheless will remain glued to the inner component.

The adhesive structural element 8 is fastened by the adhesive side 9 thereof to that side 12 of the inner component 2 which faces the outer component 3, with an excess length 13 being formed. The adhesive structural element 8 protrudes with the excess length 13 beyond the free edge 14 of the free edge section 4. The adhesive structural element 8 is glued by the fastening section 16 thereof, which is adjoined by the excess length 13, to the side 12 facing the outer component 3.

The two components 2 and 3 are then joined (FIG. 1b). When the two components 2 and 3 are joined, the excess length 13 is moved along such that the excess length 13 is arranged parallel to the fold edge 7. In this embodiment, the adhesive side 9 is still spaced apart from the free edge 14 of the free edge section 4 (FIG. 1c).

The fold edge 7 is subsequently crimped toward the inner component 2, wherein the excess length 13 is likewise moved along around the free edge 14 of the free edge section 4 such that the adhesive side 9 comes to bear against the inner component 2, i.e. is glued firmly to the latter (FIG. 1d).

The steps up to now have been carried out without the effect of heat, and this means, within the context of the invention, that the previous heating does not cause any expansion of the adhesive structural element, wherein it can be seen in FIG. 1d that the adhesive structural element 8 in the cold condition is shorter, i.e. narrower, than the fold gap 11. The adhesive structural element 8 is arranged here with the inner free edge 17 thereof within the fold gap 11 and is spaced apart from a transition 18 of the free edge section 4 of the inner component 2, i.e. from the angle between the two. The outer free edge 19 of the adhesive structural element 8, which edge is opposite the inner edge 17, is likewise spaced apart within the fold gap 11, but from the free edge 21 of the fold edge 7. An expansion space 22 and 23 is thus formed in each case.

If the fold edge 7 is crimped, i.e. the state according to FIG. 1d is reached, at least the area of the double-flanged seam is subjected to a heat treatment, i.e. is heated. In this case, a heat treatment to be carried out in an electric oven at, for example, 175° C., for example, for 10 minutes, may be sufficient for the adhesive structural element 8, i.e. the structural adhesive thereof, to be able to expand out of the fold gap 11 into the respective expansion space 22 and 23, but also in all other directions. For example, an air gap 24 which is filled after the heat treatment (FIG. 3c and FIG. 1e) can be seen in FIG. 3b. Of course, the values mentioned are mentioned merely by way of example and in no way as being limiting.

FIGS. 1e and 3c show the state after the heat treatment. The figures show that the adhesive structural element 8 has emerged, inter alia, from the fold gap 11 and a sealing bead 26, 27 is formed in each case, said sealing bead firstly settling around the free edge 21 of the fold edge 7 and secondly into the intermediate space 28 between the inner component 2 and the outer component 3 in a manner sealing both components and bridging the transition 18 of the free edge section 4 of the inner component 2. In this respect, after the heating, a filling rate of at least 100/100/>0 in particular also of critical regions, such as, for example, corners, rounded portions and also design lines can be achieved, since although the adhesive structural element 8 does not completely fill the fold gap 11, it is arranged with the free edges 17 and 19 thereof just at a small distance from the relevant elements 18 and 21. Even a filling rate of 100/100/100 can be seen in the figures.

The adhesive structural element 8 can be, for example, a hot-melt sealing tape made from an acrylate-epoxy hybrid adhesive.

FIG. 2 shows an intermediate step in which the adhesive structural element 8 is already glued by the excess length 13 thereof to the free edge 14 of the free edge section 4 before the joining. The procedure according to FIGS. 1b to 1e is then proceeded with.

FIG. 3 illustrates a further intermediate step in which the adhesive structural element is already completely connected by the excess length 13 thereof to the inner component 2. FIGS. 3a to 3c show the further procedure, which corresponds to FIGS. 1c to 1e.

In this respect, it lies within the context of the invention that the adhesive structural element 8 is moved along by the excess length 13 thereof at the latest with the crimping of the fold edge 7 around the free edge 14 of the free edge section 4, which can also be carried out before the crimping of the fold edge 7, as shown in FIGS. 2 and 3.

In the exemplary embodiment illustrated in FIG. 4, the adhesive structural element is fastened by the excess length 13 to the inner component 2, wherein the fastening portion 16 protrudes over the free edge 14. As can be seen in FIG. 5, said fastening portion is guided around the free edge 14 and glued to the inner component 2 before the two components 2 and 3 are joined. The components 2 and 3 are subsequently joined, and the procedure according to FIGS. 1c to 1e and 3a to 3c is continued with.

In the exemplary embodiment shown in FIG. 6, the adhesive structural element 8 is fastened by the adhesive side 9 thereof to the free edge 14. The excess length 13, but also the fastening portion 16 are then guided toward the inner component 2 and held on the latter in an adhesively bonding manner, wherein the adhesive structural element 8 is held in the manner which can be seen in FIG. 5. The precise procedure is described with respect to FIGS. 8a to 8c. The components 2 and 3 are subsequently joined, and the procedure according to FIGS. 1c to 1e and 3a to 3c is continued with. In the procedure example which can be seen in FIG. 7, the adhesive structural element 8 is applied to the outer component 3, with it being possible for the adhesive side 9 to face toward the inner component 2 (not illustrated). Of course, the adhesive side 9 of the adhesive structural element 8 can also face the outer component 3, and therefore the adhesive structural element 8 could be adhesively bonded to the latter. The components 2 and 3 are subsequently joined, and the procedure according to FIGS. 1c to 1e and 3a to 3c is continued with.

In a manner corresponding to the exemplary embodiment illustrated in FIG. 6, FIGS. 8a to 8c illustrate a possible procedure as to how the adhesive structural element 8 is placed around the free edge 14, i.e. around the free edge section 4 of the inner component 2. The adhesive structural element 8 is designed by way of example as a hot-melt sealing tape. The adhesive structural element 8 can be designed as a hot-melt sealing tape which is adhesive on one side or else is adhesive on two sides.

The adhesive element 8 is placed onto the free edge 14 of the free edge section 4, wherein the adhesive element 8 is deformed by the protruding limbs 29 and 31 thereof in the direction of the wing flange 4 such that the adhesive element 8 which surrounds the free edge section 4 in some regions adheres to the free edge section 4. The protruding limb 29 corresponds to the excess length 13 in the exemplary embodiment according to FIG. 6, wherein the protruding limb 31 corresponds to the fastening portion 16 in the exemplary embodiment according to FIG. 6. In order to deform the adhesive element 8 in the direction of the inner edge section 4, which can also be referred to as the wing flange, hot air nozzles 32 can be provided by way of example. The hot air heats the adhesive element 8 to such a low temperature that deformation is possible, but expansion is prevented. If the adhesive element 8 is placed around the free edge section 4 (FIG. 8c), the adhesive element 8 is cooled, with cooling to room temperature being sufficient.

All of the steps can be carried out in an automated manner, for example by means of a robot. In a preferred embodiment, strips in each case of an adaptable length of the adhesive structural element 8 are cut to size and applied to one of the two components 2, or as described above. The aim here is for the adhesive structural element 8 in the cold condition to have the width adapted in each case to the anticipated fold gap 11 such that in each case the expansion space 22 and 23 is formed, with it being possible for the adhesive structural element to have a thickness of 0.3 to 1 mm.

1. A method for producing a double-flanged seam between an inner component having a free edge section and an outer component having a fold edge arranged on an edge section, comprising at least the following steps:
producing an adhesive structural element with an extension adjusted to a fold gap to be added later on, the extension being shorter than the extension of the fold gap, wherein the adhesive structural element has an expandable structural adhesive,
applying the adhesive structural element in the cold condition onto one of the components on its side facing the other component,
crimping over the fold edge toward the inner component, wherein the adhesive structural element is bent over with an excess length around the free edge of the inner component at the latest when crimping over the fold edge, and
heating up at least the area of the double-flanged seam, thus melting the structural adhesive causing it also to leak from the fold gap in a manner expanding in all directions and forming a sealing bead.

2. The method as claimed in claim 1, characterized in that the adhesive structural element is applied with its adhesive side to the inner component.

3. The method as claimed in claim 1, characterized in that the adhesive structural element is placed in the cold condition onto the free edge of the inner component, the adhesive structural element having the excess length and a fastening portion.

4. The method as claimed in claim 1, characterized in that
the inner component and the outer component are joined when at least one fastening portion of the adhesive structural element is connected to one of the two components, wherein the excess length is moved along in the joining direction, wherein the sealing bead settles around the free edge of the fold edge.

5. The method as claimed in claim 1, characterized in that
the sealing bead settles in the intermediate space between the inner component and the outer component, bridging a transition of the free edge section of the inner component.

6. The method as claimed in claim 1, characterized in that,
in a first intermediate step before the two components are joined, the excess length of the adhesive structural element is adhesively bonded to the free edge of the free edge section, and, with the folding of the fold edge, is moved along in the direction of the inner component and adheres.

7. The method as claimed in claim 1, characterized in that, in a second intermediate step before the two components are joined, the excess length of the adhesive structural element is guided around the free edge and is completely adhesively bonded to the inner component.

8. The method as claimed in claim 1, characterized in that
the adhesive structural element is placed with its excess length on the free edge section of the inner component, and the fastening portion is guided around the free edge and is fastened to the inner component.

9. The method as claimed in claim 1, characterized in that
the adhesive structural element is applied piece by piece as a strip or in one piece.

10. The method as claimed in claim 1, characterized in that
the adhesive structural element is heated, the excess length and a fastening portion are each guided around the free edge and fastened to the inner component.

11. The method as claimed in claim 1, characterized in that
the adhesive structural element is blasted with hot air for heating purposes.

12. The method as claimed in claim 1, characterized in that
the adhesive structural element is subjected to an air jet or to a plurality of air jets for gluing purposes.

13. The method as claimed in claim 1, characterized in that
the adhesive structural element is blasted with hot air for heating and gluing purposes.

14. The method as claimed in claim 1, characterized in that
the adhesive structural element is glued under the effect of gravitational force.

15. The method as claimed in claim 1, characterized in that
the adhesive structural element is pressed on, preferably after the adhesive structural element has been heated for fastening purposes.
